(19) United States
(12) Patent Application Publication
(10) Pub. No.: US 2010/0070541 A1
(43) Pub. Date: Mar. 18, 2010

(54) STUDENT INFORMATION STATE REPORTING SYSTEM

(75) Inventor: Scott John Orr, Wheaton, IL (US)

Correspondence Address: K&L Gates LLP, P.O. Box 1135, CHICAGO, IL, 60690, US

(73) Assignee: METAPHOR SOFTWARE, INC., Glen Ellyn, IL (US)

(21) Appl. No.: 12/553,741

(22) Filed: Sep. 3, 2009

Related U.S. Application Data
(60) Provisional application No. 61/093,750, filed on Sep. 3, 2008.

(51) Int. Cl. G06F 17/30

(52) U.S. Cl. 707/811; 707/E17.123

(57) ABSTRACT

The present disclosure provides a student information state reporting system. The disclosed system allows a user to define a form that includes questions for capturing data elements related to a state report. The user also associates the form with a snapshot for automatic synchronization of at least one of the data elements. In addition, the user defines at least one field in the form to be included in the snapshot and automatically synchronized. Next, the user 118 associates the form with an output definition that matches a state report format. Preferably, an output based on the output definition for the state report is automatically scheduled, and the automatic synchronization is only applied when in an on-line mode.

### PRIORITY CLAIM

This application claims the benefit of U.S. Provisional Patent Application No. 61/093,750, filed Sep. 3, 2008, entitled “Student Information State Reporting System,” the entire contents of which are hereby incorporated by reference.

### TECHNICAL FIELD

The present application relates in general to state reporting requirements and more specifically to a student information state reporting system.

### BACKGROUND

Existing student information systems (SIS) have to continually update their product data model to meet ongoing State report requirement changes. In addition, existing student information systems require double entry in the SIS system and the associated data snapshots.

The disclosed functionality allows users to define forms for capturing non-native data elements. The system forms management features may integrated with other software or used in a stand-alone mode with other SIS systems.

The disclosed system allows a user to define a form that includes questions for capturing data elements related to a state report. The user also associates the form with a snapshot for automatic synchronization of at least one of the data elements. In addition, the user defines at least one field in the form to be included in the snapshot and automatically synchronized. Next, the user 118 associates the form with an output definition that matches a state report format. Preferably, an output based on the output definition for the state report is automatically scheduled, and the automatic synchronization is only applied when in an on-line mode.

### BRIEF DESCRIPTION OF THE FIGURES

FIG. 1 is a high level block diagram of an example communications system.

FIG. 2 is a more detailed block diagram showing one example of a computing device.

FIG. 3 is an example systems forms management screen shot.

FIG. 4 is an example systems forms management: questions screen shot.

FIG. 5 is an example systems forms management: validation screen shot.

FIG. 6 is an example systems forms management: table tracker screen shot.

FIG. 7 is an example systems forms management: snapshot synchronization screen shot.

FIG. 8 is an example systems forms management: output screen shot.

FIG. 9 is an example systems forms management: form entry screen shot.

FIG. 10 is an example snapshots screen shot.

FIG. 11 is a flowchart showing one example of a process for reporting student information.

### DETAILED DESCRIPTION

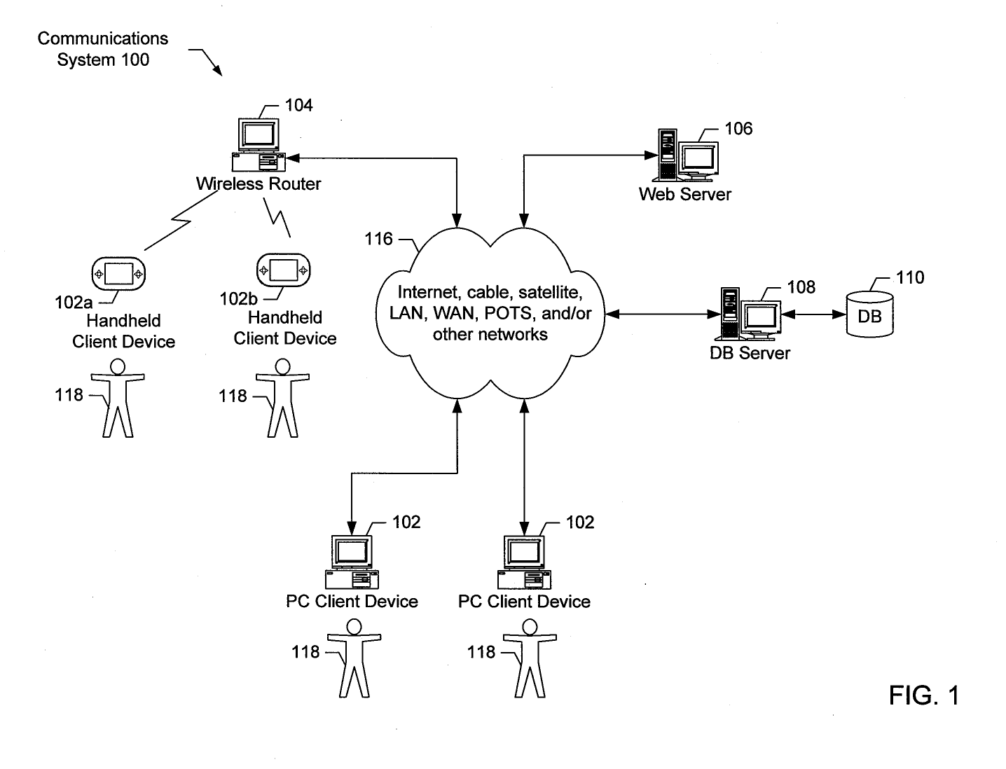

The disclosed system is most readily realized in a network communications system. A high level block diagram of an exemplary network communications system 100 is illustrated in FIG. 1. The illustrated system 100 includes one or more client devices 102, one or more wireless routers 104, one or more web servers 106, and one or more database servers 108 connected to one or more databases 110. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

In an example mode of operation, users 118 of the system 100 consume one or more web pages received from the web server 106. The web pages may be any suitable type of web page.

One web server 106 may interact with a large number of client devices 102. Accordingly, each web server 106 is typically a high end computing device with a large storage capacity, one or more fast microprocessors, and one or more high speed network connections. Conversely, relative to a typical web server 106, each client device 102 typically includes less storage capacity, less processing power, and a slower network connection.

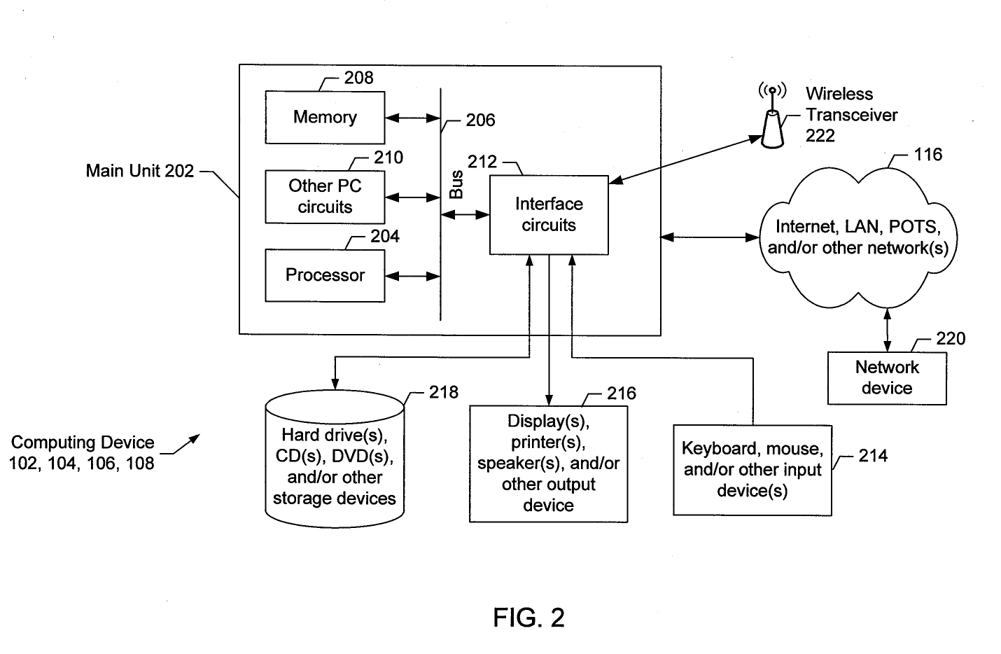

A detailed block diagram of an example computing device 102, 104, 106, 108 is illustrated in FIG. 2. Each computing device 102, 104, 106, 108 may include a server, a personal computer (PC), a personal digital assistant (PDA), a portable audio player, a portable audio/video player, a mobile telephone, and/or any other suitable computing device. Each computing device 102, 104, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions that interact with the other devices in the system 100 as described herein. These software instructions may be executed by the processor 204 in any suitable manner. The memory 208 and/or another storage device 218 may also store one or more data structures, digital data indicative of documents, files, programs, web pages, etc. retrieved from another computing device 102, 104, 106, 108 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the computing device 102, 104, 106, 108. For example, the display 216 may be used to display web pages received from the web server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 104, 106, 108.

Each computing device 102, 104, 106, 108 may also exchange data with other computing devices 102, 104, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users of the system 100 may be required to register with the web server 106. In such an instance, each user may choose a user identifier (e.g., e-mail address) and a password which may be required for the activation of services. The user identifier and password may be passed across the communication channel(s) 116 using encryption built into the user's browser, software application, or device. Alternatively, the user identifier and/or password may be assigned by the web server 106.

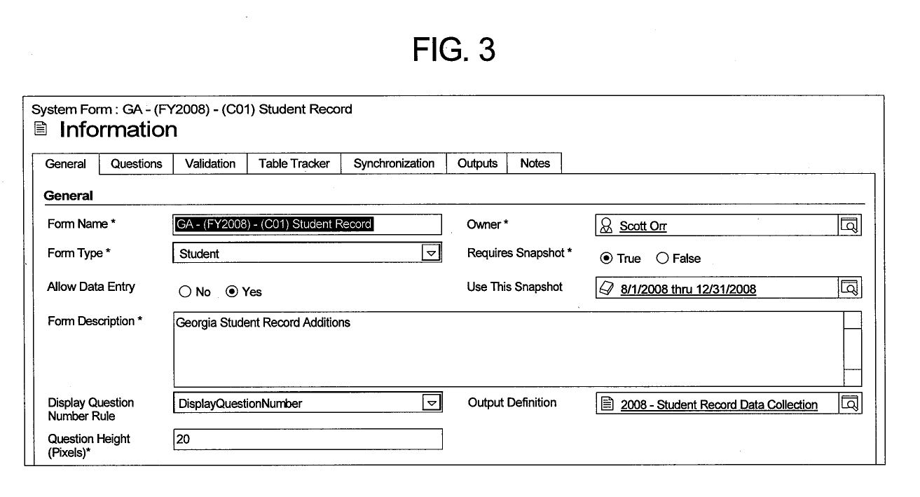

An example systems forms management screen shot is illustrated in FIG. 3. This screen may be used to define new forms and questions for capturing new data elements related to state reporting. In addition, this screen may be used to define new forms and questions for capturing new data elements related to any form/data capturing needs. These forms may facilitate data entry, or these forms may only be used for reporting purposes. In addition, the user 118 may associate a form with a snapshot for automatic synchronization of key data elements. Similarly, the user 118 may associate a form with an output definition that matches a state report format.

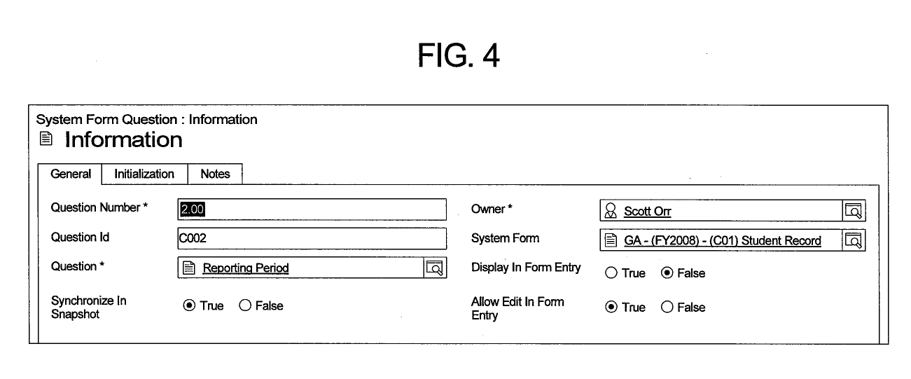

An example systems forms management: questions screen shot is illustrated in FIG. 4. This screen may be used to define questions that support a variety of data input types. For example, data input types may include string, decimal, integer, datetime, boolean, picklists and/or ranges. This screen may also be used to setup initialization rules. For example, initialization rules may include defaults, specifics, values from questions on the same or other forms, responses from other forms, other table fields, customization dynamic link libraries (DLLs), etc.

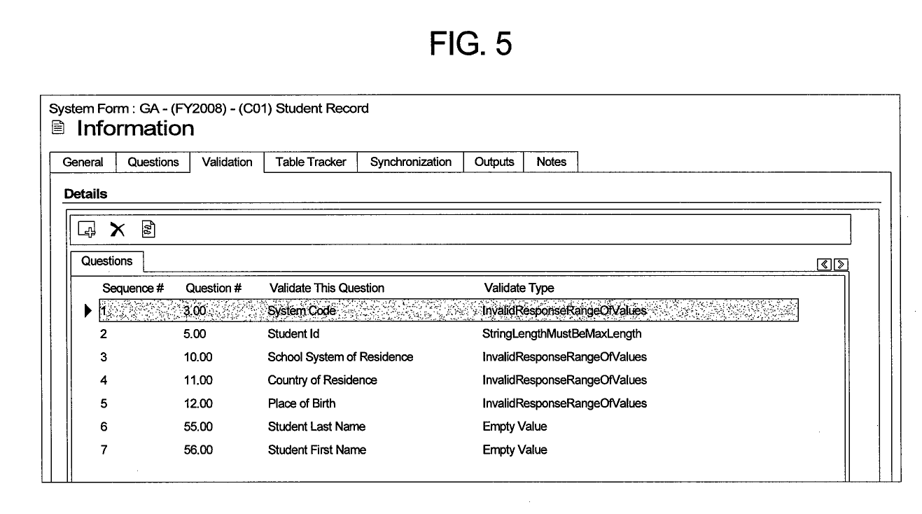

An example systems forms management: validation screen shot is illustrated in FIG. 5. This screen may be used to define an unlimited number of validation rules. For example, validation rules may include empty values, range checks, dependent questions and their answers, etc. These validation rules may be automatically applied during form entry and/or data imports.

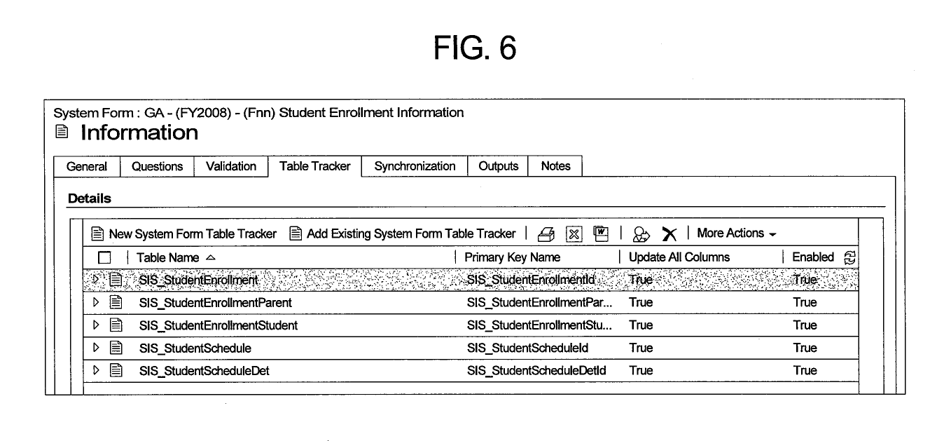

An example systems forms management: table tracker screen shot is illustrated in FIG. 6. This screen may be used to define non-system form tables and/or fields to be included in snapshots and automatically synchronized.

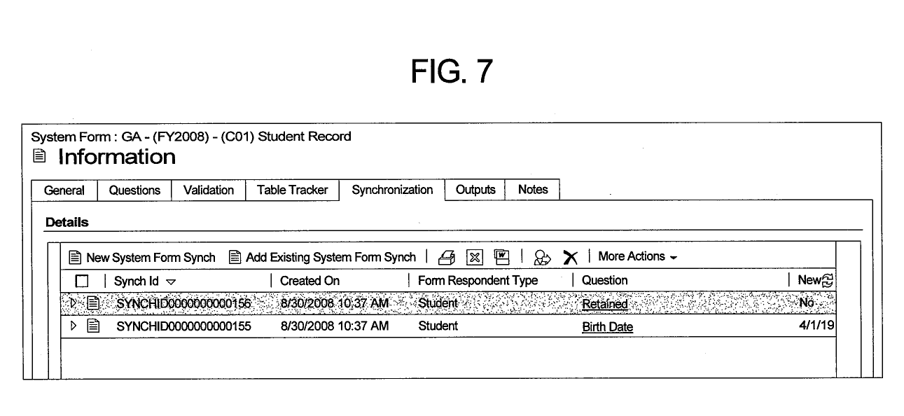

An example systems forms management: snapshot synchronization screen shot is illustrated in FIG. 7. Preferably, all changes made to a form or tracked tables are tracked and recorded. In addition, the user 118 may schedule snapshot synchronizations to be performed by the system's processor.

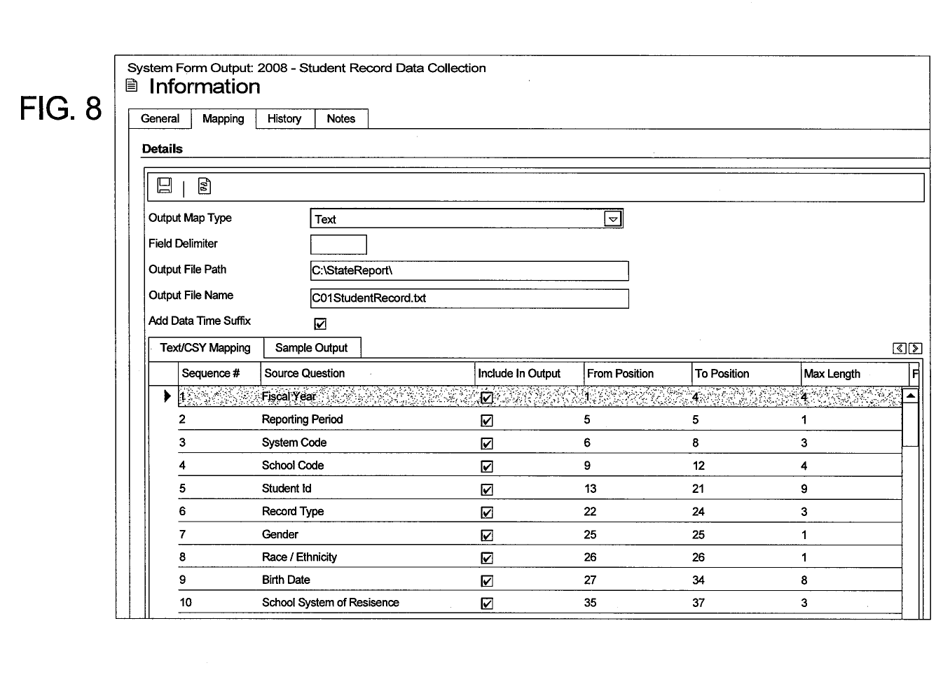

An example systems forms management: output screen shot is illustrated in FIG. 8. Any suitable output type may be used. For example, output types of text, comma separated values (CSV), and/or extensible markup language (XML) may be used. In addition, the user 118 may define output positions, lengths and/or format strings. Still further, the user 118 may preview outputs to ensure accuracy. For the XML output type, the user may load XML definitions and map form question/responses to XML elements. Preferably, the output is automatically scheduled for the state reporting features.

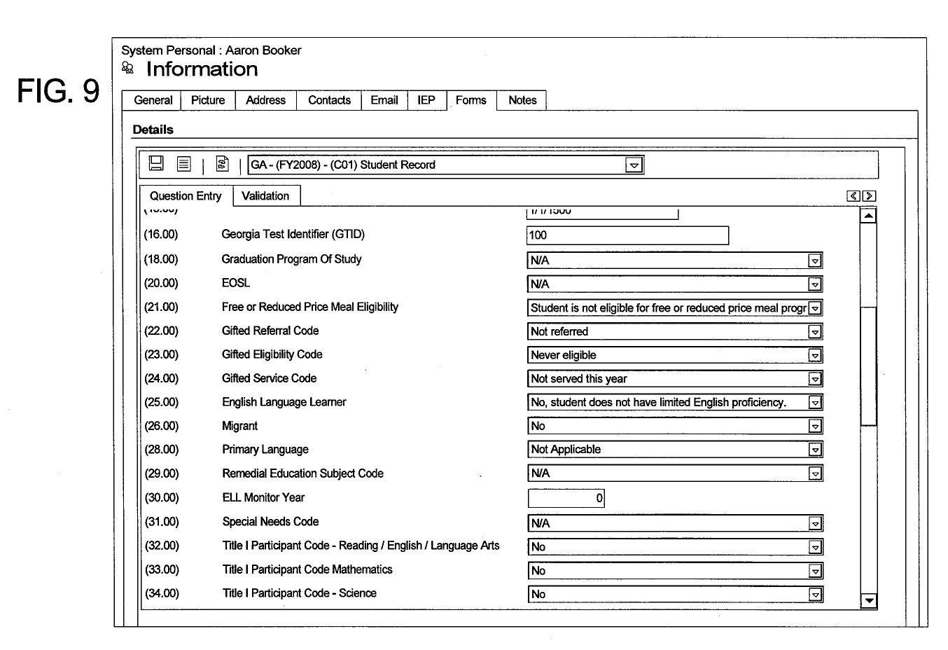

An example systems forms management: form entry screen shot is illustrated in FIG. 9. Preferably, the form entry features are automatically integrated with system based upon associated form type. Example types include student, staff, portal user, business unit, etc. Forms may be dynamically created based upon questions and initialization rules. The format of questions may be customized. For example, the display of a question number, a question identifier (ID), and/or the height of question to accommodate word wrapping may be customized. Questions may be made read only or not visible based upon the individual requirements. Preferably, forms ensure valid data is captured based upon defined validation rules.

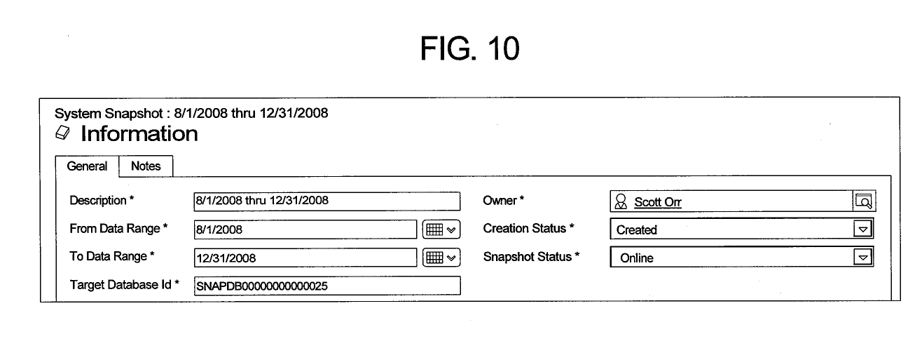

An example snapshots screen shot is illustrated in FIG. 10. This screen supports the tracking of data elements from an unlimited number of system forms. In addition, this screen supports on-line and off-line modes, and preferably only applies synchronization requests when online.

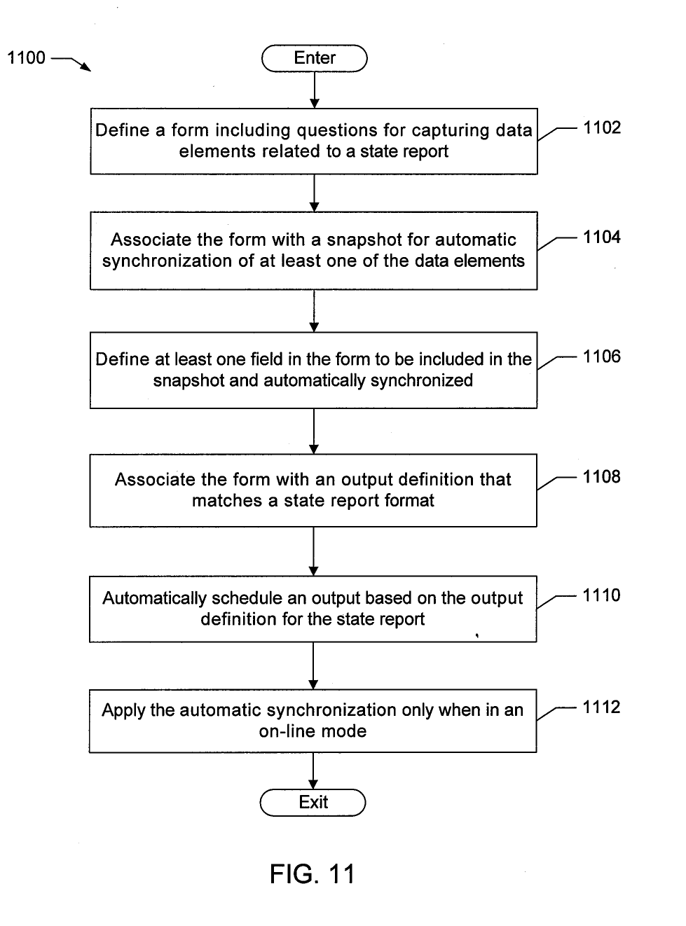

A flowchart of an example process 1100 for reporting student information is illustrated in FIG. 11. Preferably, the process 1100 is embodied in one or more software programs which is stored in one or more memories and executed by one or more processors. Although the process 1100 is described with reference to the flowchart illustrated in FIG. 11, it will be appreciated that many other methods of performing the acts associated with process 1100 may be used. For example, the order of many of the steps may be changed, and some of the steps described may be optional.

The process 1100 preferably begins when a user 118 defines a form including questions for capturing data elements related to a state report (block 1102). Next, the user 118 associates the form with a snapshot for automatic synchronization of at least one of the data elements (block 1104). In addition, the user defines at least one field in the form to be included in the snapshot and automatically synchronized (block 1106). Next, the user 118 associates the form with an output definition that matches a state report format (block 1108). Preferably, an output based on the output definition for the state report is automatically scheduled (block 1110), and the automatic synchronization is only applied when in an on-line mode (block 1112).

In summary, persons of ordinary skill in the art will readily appreciate that a student information state reporting system has been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of reporting student information, the method comprising:
defining a form including questions for capturing data elements related to a state report;
associating the form with a snapshot for automatic synchronization of at least one of the data elements;
defining at least one field in the form to be included in the snapshot and automatically synchronized;
associating the form with an output definition that matches a state report format;
automatically scheduling an output based on the output definition for the state report; and
applying the automatic synchronization only when in an on-line mode.

2. The method of claim 1, wherein the form includes questions for capturing other data elements that are not related to state reporting.

3. The method of claim 1, wherein the form is used for generating a report.

4. The method of claim 1, including defining a plurality of questions associated with a plurality of different data input types of the form.

5. The method of claim 1, including establishing a plurality of initialization rules associated with the form.

6. The method of claim 1, including establishing a plurality of validation rules associated with the form.

7. The method of claim 1, including loading an XML definition and mapping a form question/response to an XML element.

8. An apparatus for reporting student information, the apparatus comprising:
a processor;
an input device operatively coupled to the processor;
an output device operatively coupled to the processor; and
a memory device operatively coupled to the processor, the memory device storing instructions to cause the processor to:
receive a definition of a form including questions for capturing data elements related to a state report;
associate the form with a snapshot for automatic synchronization of at least one of the data elements;
receive a definition of at least one field in the form to be included in the snapshot and automatically synchronized;
associate the form with an output definition that matches a state report format;
automatically schedule an output based on the output definition for the state report; and
apply the automatic synchronization only when in an on-line mode.

9. The apparatus of claim 8, wherein the form includes questions for capturing other data elements that are not related to state reporting.

10. The apparatus of claim 8, wherein the form is used for generating a report.

11. The apparatus of claim 8, wherein the memory device stores instructions to cause the processor to store a plurality of questions associated with a plurality of different data input types of the form.

12. The apparatus of claim 8, wherein the memory device stores instructions to cause the processor to store a plurality of initialization rules associated with the form.

13. The apparatus of claim 8, wherein the memory device stores instructions to cause the processor to store a plurality of validation rules associated with the form.

14. The apparatus of claim 8, wherein the memory device stores instructions to cause the processor to store an XML definition and a mapping of a form question/response to an XML element.

15. A computer readable memory device storing instructions to cause a computing device to:
receive a definition of a form including questions for capturing data elements related to a state report;
associate the form with a snapshot for automatic synchronization of at least one of the data elements;
receive a definition of at least one field in the form to be included in the snapshot and automatically synchronized;
associate the form with an output definition that matches a state report format;
automatically schedule an output based on the output definition for the state report; and
apply the automatic synchronization only when in an on-line mode.

16. The computer readable memory device of claim 15, wherein the form includes questions for capturing other data elements that are not related to state reporting.

17. The computer readable memory device of claim 15, wherein the form is used for generating a report.

18. The computer readable memory device of claim 15, wherein the memory device stores instructions to cause the computing device to store a plurality of questions associated with a plurality of different data input types of the form.

19. The computer readable memory device of claim 15, wherein the memory device stores instructions to cause the computing device to store a plurality of initialization rules associated with the form.

20. The computer readable memory device of claim 15, wherein the memory device stores instructions to cause the computing device to store a plurality of validation rules associated with the form.

21. The computer readable memory device of claim 15, wherein the memory device stores instructions to cause the computing device to store an XML definition and a mapping of a form question/response to an XML element.
